(19) United States
(12) Patent Application Publication
(10) Pub. No.: US 2020/0167116 A1
(43) Pub. Date: May 28, 2020

(54) VEHICLE DISPLAY DEVICE, AND VEHICLE DISPLAY METHOD

(71) Applicant: HONDA MOTOR CO., LTD., Tokyo (JP)

(72) Inventors: Tomohisa Manabe, Tokyo (JP); Mirai Aki, Wako-shi (JP); Masaru Aoki, Wako-shi (JP); Kotaro Higuchi, Wako-shi (JP)

(21) Appl. No.: 16/669,673

(22) Filed: Oct. 31, 2019

(30) Foreign Application Priority Data
Nov. 22, 2018 (JP) 2018-219175

(51) Int. Cl. G06F 3/14; G06F 3/0488; B60K 35/00

(52) U.S. Cl. CPC G06F 3/1423; G06F 3/04886; G06K 9/00838; G06F 2203/04803; B60K 35/00

(57) ABSTRACT

A vehicle display device includes a first display which is provided at a position where the first display is visually recognizable by a driver and has a touch panel function, a second display which is provided at a position closer to a seat next to the driver than the first display is in a vehicle width direction and has a touch panel function , and a controller configured to set one or more first operation buttons in the first display irrespective of the presence or absence of an occupant in the driver's seat, set one or more second operation buttons in the second display in a case where an occupant is present in the seat next to the driver, and not set the second operation button in the second display in a case where an occupant is not present in the seat next to the driver.

### CROSS-REFERENCE TO RELATED APPLICATION

Priority is claimed on Japanese Patent Application No. 2018-219175, filed Nov. 22, 2018, the content of which is incorporated herein by reference.

### BACKGROUND

### Field of the Invention

The present invention relates to a vehicle display device, and a vehicle display method.

### Description of Related Art

In the related art, a control device that sets a standby state of low power consumption which is a state where a screen is not displayed on a display at the time of receiving an open door signal for opening a door of a vehicle, and shifts a state from a standby state to a normal state where a screen is displayed at the time of detecting a driver's boarding has been disclosed (Japanese Unexamined Patent Application, First Publication No. 2008-179212).

However, in the above-described device, only a driver's boarding is considered, and there is a case where other occupants are not considered.

### SUMMARY

The present invention is contrived in view of such circumstances, and an object thereof is to provide a vehicle display device, a vehicle display method, and a storage medium which are capable of achieving both operability and visibility.

A vehicle display device, a vehicle display method, and a storage medium according to the present invention adopt the following configurations.

(1) A vehicle display device according to an aspect of the present invention includes a first display which is provided at a position where the first display is visually recognizable by a driver inside a vehicle and has a touch panel function in at least a portion the first display, a second display which is provided at a position closer to a seat next to the driver's seat than the first display is in a vehicle width direction and has a touch panel function in at least a portion of the second display, and a controller which is configured to set one or more first operation buttons for receiving an input operation in the first display irrespective of the presence or absence of an occupant in the driver's seat, set one or more second operation buttons for receiving an input operation in the second display in a case where an occupant is present in the seat next to the driver's seat, and not set the second operation button in the second display in a case where an occupant is not present in the seat next to the driver's seat.

(2) In the aspect of (1), the controller may set the second operation button so that the second operation button to a position that is biased to a side far from the driver's seat in the vehicle width direction of the second display in a case where the second operation button is set in the second display.

(3) In the aspect of (1) or (2), the controller may set the first operation button so that the first operation button to a position that is biased to a side far from the seat next to the driver's seat in the vehicle width direction of the first display.

(4) In the aspect of any one of (1) to (3), the controller may further display one or more first contents in the first display irrespective of the presence or absence of an occupant in the driver's seat.

(5) In the aspect of any one of (1) to (4), the controller may further display one or more second contents in the second display in a case where an occupant is present in the seat next to the driver's seat.

(6) In the aspect of any one of (1) to (5), the controller may display a second content without setting the second operation button in the second display in a case where an occupant is not present in the seat next to the driver's seat.

(7) In the aspect of any one of (1) to (6), the controller may set one or more third operation buttons for receiving an operation of a function to be executed using a specific program in the first display irrespective of the presence or absence of an occupant in the driver's seat, and may not set the third operation button in the second display even when an occupant is present in the seat next to the driver's seat.

(8) A vehicle display device according to another aspect of the present invention includes a first display group which is provided at a position where the first display group is visually recognizable by a driver inside a vehicle and includes one or more first displays having a touch panel function in at least a portion of the first display, a second display group which is provided at a position closer to a seat next to the driver's seat than the first display group is in a vehicle width direction, includes a plurality of second displays, and includes one or more second displays having a touch panel function in at least a portion of the second display, and a controller which is configured to set one or more first operation buttons for receiving an input operation in the one or more first displays of the first display group irrespective of the presence or absence of an occupant in the driver's seat, set one or more second operation buttons for receiving an input operation in the one or more second displays of the second display group in a case where an occupant is present in the seat next to the driver's seat, and not set the second operation button in the one or more second displays of the second display group in a case where an occupant is not present in the seat next to the driver's seat.

(9) A vehicle display device according to still another aspect of the present invention includes a display which is provided at a position where the display is visually recognizable by a driver inside a vehicle and an occupant in a seat next to the driver's seat and has a touch panel function in at least a portion of the display, and a controller which is configured to set a first operation button for receiving one or more input operations in a first specific region of the display irrespective of the presence or absence of an occupant in the driver's seat, set one or more second operation buttons for receiving an input operation in a second specific region which is a region closer to the seat next to the driver's seat than the first specific region is in a vehicle width direction in a case where an occupant is present in the seat next to the driver's seat, and not set the one or more second operation buttons in the second specific region in a case where an occupant is not present in the seat next to the driver's seat.

(10) A vehicle display method according to still another aspect of the present invention includes causing a computer provided in a vehicle to set one or more first operation buttons for receiving an input operation in a first display which is provided at a position where the first display is visually recognizable by a driver inside the vehicle irrespective of the presence or absence of an occupant in the driver's seat and has a touch panel function in at least a portion of the first display, to set one or more second operation buttons for receiving an input operation in a second display which is provided at a position closer to a seat next to the driver's seat than the first display is in a vehicle width direction in a case where an occupant is present in the seat next to the driver's seat and has a touch panel function in at least a portion of the second display, and not to set the second operation button in the second display in a case where an occupant is not present in the seat next to the driver's seat.

(11) A storage medium according to still another aspect of the present invention stores a program causing a computer provided in a vehicle to set one or more first operation buttons for receiving an input operation in a first display which is provided at a position where the first display is visually recognizable by a driver inside the vehicle irrespective of the presence or absence of an occupant in the driver's seat and has a touch panel function in at least a portion of the first display, to set one or more second operation buttons for receiving an input operation in a second display which is provided at a position closer to a seat next to the driver's seat than the first display is in a vehicle width direction in a case where an occupant is present in the seat next to the driver's seat and has a touch panel function in at least a portion of the second display, and not to set the second operation button in the second display in a case where an occupant is not present in the seat next to the driver's seat.

According to (1) to (11), it is possible to achieve both visibility and operability. In a case where an occupant is not present on a seat next to a driver's seat, for example, information not necessary for the driver is not displayed, and thus comfortability and visibility for the driver are improved. In a case where an occupant is not present on the seat next to the driver's seat, visibility for the driver is improved, for example, when a content is displayed in a large size. In a case where an occupant is present on the seat next to the driver's seat, for example, a second operation button is set, and an occupant can operate the second operation button to perform desired control and to display a desired content on a display, thereby improving operability of the occupant.

### BRIEF DESCRIPTION OF THE DRAWINGS

FIG. 1 is a diagram showing an example of a configuration of a display system mounted on a vehicle.

FIG. 2 is a diagram showing examples of a display and a vehicle information display which are provided inside a vehicle.

FIG. 3 is a diagram showing an example of images displayed on a first touch panel and a second touch panel.

FIG. 4 is a diagram showing an example of details of display correspondence information.

FIG. 5 is a diagram showing an outline of processing executed by a display control device.

FIG. 6 is a diagram showing an example of a change in a display mode in a pattern (2).

FIG. 7 is a diagram showing an example of a change in a display mode in a pattern (3).

FIG. 8 is a flowchart showing a flow of processing executed by the display control device.

FIG. 9 is a diagram showing an outline of processing of a display controller according to a second embodiment.

FIG. 10 is a sequence diagram showing a flow of processing in an invalid state.

FIG. 11 is a sequence diagram showing a flow of another processing in an invalid state.

FIG. 12 is a diagram showing an example of a functional configuration of a display system according to a third embodiment.

FIG. 13 is a diagram showing an example of a state when an operation button is controlled such that it is brought into a display state or a non-display state.

FIG. 14 is a diagram showing an example of operation buttons displayed on a first touch panel and a second touch panel according to a fifth embodiment.

FIG. 15 is a diagram showing an example of a touch panel according to a sixth embodiment.

FIG. 16 is a diagram showing an example of a display included in a display according to a seventh embodiment.

FIG. 17 is a diagram showing an example of a hardware configuration of a display control device according to the embodiment.

### DETAILED DESCRIPTION

Hereinafter, embodiments of a vehicle display device, a vehicle display method, and a storage medium of the present invention will be described with reference to the accompanying drawings. A display system including the vehicle display device is provided in, for example, a vehicle not shown in the drawing. A driving source of the vehicle is, for example, an electric motor, an internal combustion engine such as a diesel engine or a gasoline engine, or a combination thereof. The electric motor is operated using discharge power of a secondary battery or a fuel cell or power generated by a generator connected to an internal combustion engine.

In the following description, a positional relationship and the like will be appropriately described using an XYZ coordinate system. An X-direction is a central axis direction (moving direction) of a vehicle body, and a Y-direction is a width direction of the vehicle, that is, a direction orthogonal to the X-direction in a horizontal plane. A Z-direction is a direction orthogonal to the X-direction and the Y-direction.

### FIRST EMBODIMENT

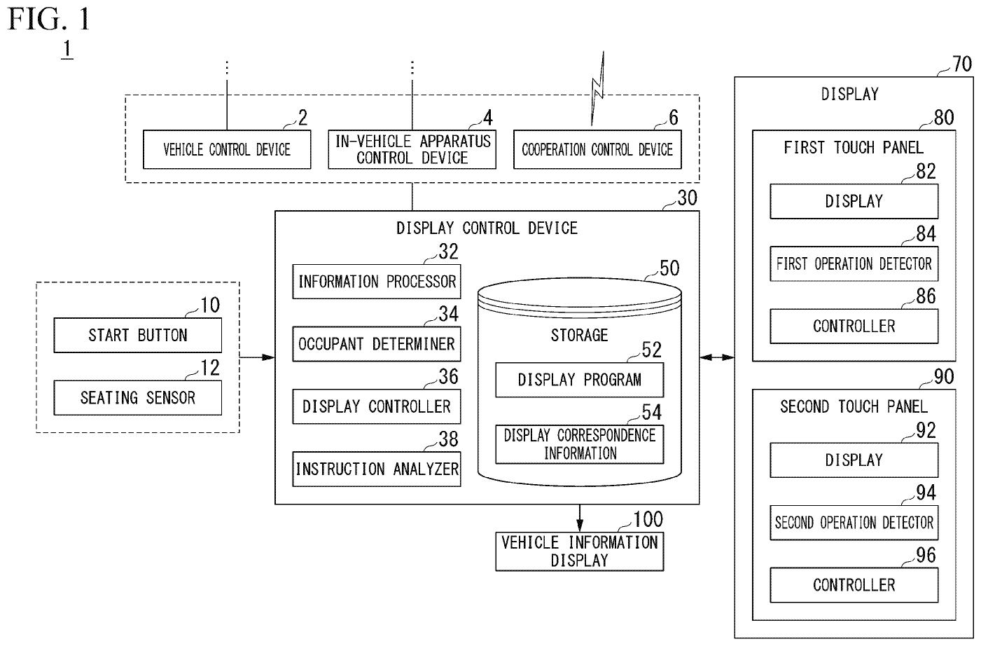

FIG. 1 is a diagram showing an example of a configuration of a display system 1 mounted on a vehicle. The display system 1 includes a vehicle control device 2, an in-vehicle apparatus control device 4, a cooperation control device 6, a start button 10, a seating sensor 12, a display control device 30, a display 70, and a vehicle information display 100.

The vehicle control device 2 is a control device that controls a specific control apparatus related to the driving, braking, steering, and the like of the vehicle. The vehicle travels or stops in a lane through a driver's operation and the control of the specific control apparatus. The vehicle control device 2 controls a target specific control apparatus in accordance with an occupant's operation performed on the display 70.

The in-vehicle apparatus control device 4 is a control device that controls in-vehicle apparatuses (for example, an air conditioner, a car navigation system, an audio, and the like) which are mounted on the vehicle. The in-vehicle apparatus control device 4 controls a target in-vehicle apparatus in accordance with an occupant's operation performed on the display 70.

The cooperation control device 6 controls communication with an external cooperation apparatus that can communicate therewith through a wired cable. The wired cable is connected to a connection interface such as a universal serial bus (USB) port. The cooperation control device 6 controls communication with a cooperation apparatus paired therewith using short distance wireless communication. In a state where communication with an external apparatus is established, the cooperation control device 6 controls a cooperation apparatus or starts an application program (application) to execute a function of the application in accordance with an occupant's operation performed on the display 70. The application is an application program installed in the cooperation apparatus. For example, the application is stored in a storage device of the cooperation apparatus. The storage device is, for example, a non-volatile memory.

The start button 10 is, for example, a button for controlling a power supply of the vehicle such that it in an on state. When the start button 10 is operated by an occupant, an electronic control unit (ECU) not shown in the drawing controls the power supply of the vehicle such that it is brought into an on state. When the start button 10 is operated, a power-on signal is output to the display control device 30. The display control device 30 controls power supplies of the display 70 and the vehicle information display 100 such that they are brought into an on state on the basis of a power-on signal.

In a case where the display control device 30 acquires an accessory-on signal for controlling an accessory such that it is brought into an on state (ACC on state) instead of a power-on signal, the power supplies of the display 70 and the vehicle information display 100 may be controlled such that it is brought into an on state. In this case, the start button 10 outputs an accessory-on signal on the basis of an occupant's operation.

The seating sensor 12 is provided at, for example, at least a seat next to the driver's seat among seats in the vehicle. The seating sensor 12 includes one or more pressure detection elements and outputs detection results of the one or more pressure detection elements to the display control device 30.

### [Display Control Device]

The display control device 30 includes, for example, an information processor 32, an occupant determiner 34, a display controller 36, an instruction analyzer 38, and a storage 50. The information processor 32, the occupant determiner 34, the display controller 36, and the instruction analyzer 38 are realized by causing a computer processor such as a central processing unit (CPU) to execute a display program (software) 52. Some or all of these components may be realized by hardware (a circuit unit; circuitry is included) such as a large scale integration (LSI), an application specific integrated circuit (ASIC), a field-programmable gate array (FPGA), or a graphics processing unit (GPU), or may be realized by cooperation of software and hardware. The display program 52 may be stored in the storage 50 of the display control device 30 in advance as shown in the drawing, may be stored in a detachable storage medium (non-transitory storage medium) such as a DVD or a CD-ROM, or may be installed in the storage 50 by a storage medium being mounted on a drive device. Among the above-described functional units, a predetermined functional unit may be integrated with another functional unit, and processing executed by another functional unit may be performed by a functional unit different from the above-described functional unit.

The storage 50 is realized by a storage device including a non-transitory storage medium such as an HDD, a flash memory, an electrically erasable programmable read only memory (EEPROM), or a read only memory (ROM), a random access memory (RAM), or the like. The storage 50 stores, for example, programs read and executed by a processor, and the like. As described above, the display program 52 and display correspondence information 54 to be described later are stored in the storage 50.

The information processor 32 acquires information output by the vehicle control device 2, the in-vehicle apparatus control device 4, the cooperation control device 6, the start button 10, the seating sensor 12, and the like, and manages the acquired information. The information processor 32 provides processing results of the display control device 30 to the vehicle control device 2, the in-vehicle apparatus control device 4, the cooperation control device 6, and the like.

The occupant determiner 34 determines whether or not an occupant is sitting on a seat on the basis of information provided by the seating sensor 12. For example, in a case where a pressure value acquired from the seating sensor 12 is equal to or greater than a predetermined value, the occupant determiner 34 determines that the occupant is sitting on a seat. For example, in a case where all pressure values detected by a plurality of pressure detection elements included in the seating sensor 12 or pressure values of pressure detection elements at a predetermined proportion or more are equal to or greater than a predetermined value, the occupant determiner 34 may determine that an occupant is sitting on a seat.

For example, in a case where information indicating the distribution of pressure applied to a seat which is output by the seating sensor 12 is consistent with information indicating distribution at the time of sitting on a seat stored in the storage 50 in advance, the occupant determiner 34 may determine that an occupant is sitting on a seat next to a driver's seat. In this case, it is possible to discriminate a user, and thus control such as “setting a second operation switch only when a specific user sits on a seat” can also be performed. The consistency is not limited to complete consistency and includes consistency to a predetermined degree.

The display controller 36 sets one or more first operation buttons for receiving an input operation on a first display (for example, a first touch panel 80) of the display 70 irrespective of the presence or absence of an occupant on a driver's seat. That is, the display controller 36 automatically displays the first operation button in a case where a power supply state of the vehicle, a display mode, and the like satisfy standards.

The display controller 36 sets one or more second operation buttons for receiving an input operation on a second display (for example, a second touch panel 90) in a case where an occupant is present on a seat next to a driver's seat, and does not set the second operation button on the second display (for example, the second touch panel 90) in a case where an occupant is not present on the seat next to the driver's seat. That is, the display controller 36 displays or does not display one or more second operation buttons on the second touch panel 90 of the display 70 on the basis of the presence or absence of an occupant on the seat next to the driver's seat. In a case where the first operation button and the second operation button are not distinguished from each other, the operation buttons may be referred to simply as an “operation button”.

The “setting” refers to the display of an operation button, for example, in a state where the display controller 36 receives an occupant's operation (a state where the operation is reflected) in a case where the occupant operates the operation button. In a case where a set operation button is operated, an apparatus related to an operation is controlled in accordance with the operation, or a function related to the operation is executed. Details of these processes will be described later. In a first embodiment, the term “display” means “setting”.

In a case where it is detected that a touch operation has been performed on a position related to the first operation button or the second operation button, the instruction analyzer 38 analyzes information regarding the operation (operation information) in accordance with rules which are set in advance and outputs the analyzed information after analysis to a device corresponding to the operation. The analyzed information is information for controlling the device related to the operation or information for executing a function related to the operation. The vehicle control device 2, the in-vehicle apparatus control device 4, or the cooperation control device 6 which is a device corresponding to an operation controls a target apparatus corresponding to an operation or executes a function on the basis of the analyzed information.

### [Display]

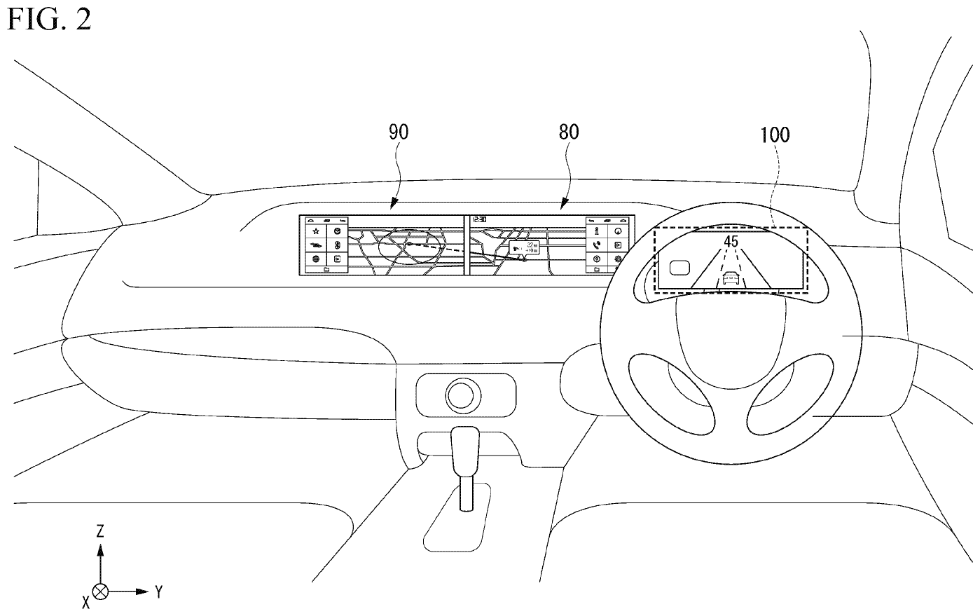

The display 70 includes, for example, a first touch panel 80 and a second touch panel 90. The touch panel is a device in which a display displaying information and a mechanism for receiving the input of an operation of bringing an indicator into contact with the display are integrated with each other. The display 70 will be described with reference to FIGS. 1 and 2.

FIG. 2 is a diagram showing examples of the display 70 and the vehicle information display 100 which are provided inside the vehicle. The first touch panel 80, which is a display for a driver, is disposed at a position easily visually recognized by the driver (a visually recognizable position), and the second touch panel 90, which is a display for a driver or another occupant (an occupant sitting on a seat next to the driver's seat), is disposed at a position where the second touch panel is visually recognizable by the driver or the occupant.

The first touch panel 80 is provided in a forward direction (X-direction) from the driver's seat in an instrument panel inside the vehicle. The first touch panel 80 is disposed, for example, on the driver's seat side or in the vicinity of the center of the instrument panel inside the vehicle.

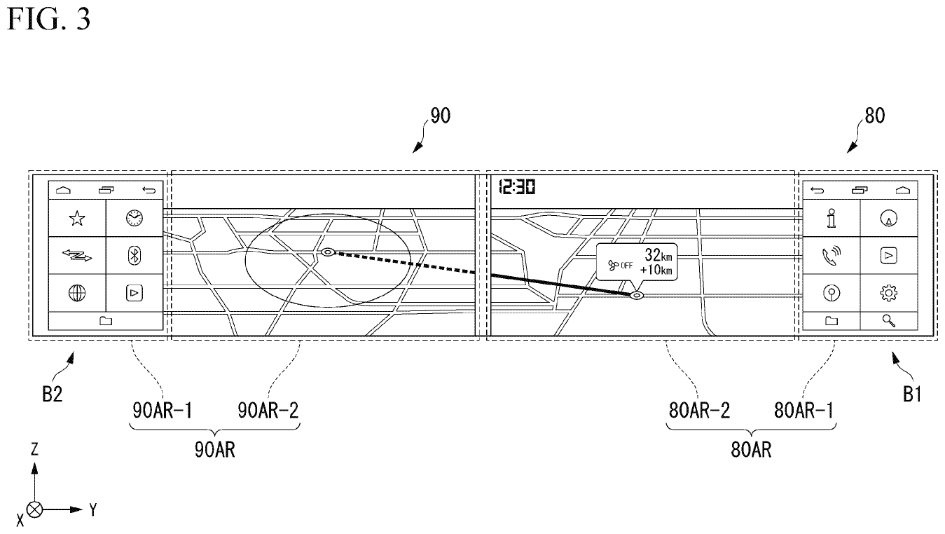

The second touch panel 90 is provided at a position in a vehicle width direction (Y-direction) with respect to the first display, the position (a position on the minus Y-direction side) being closer to a seat next to the driver's seat than the first touch panel 80 is. For example, the second touch panel 90 may be provided adjacent to the first touch panel 80. For example, a display surface of the first touch panel 80 and a display surface of the second touch panel 90 may be juxtaposed so as to form substantially the same surface in the forward direction (in the X-direction). Information to be displayed on the first touch panel 80 and the second touch panel 90 will be described in FIG. 3 later.

The first touch panel 80 is, for example, a touch panel type display including a display 82, a first operation detector 84, and a controller 86. The display 82 is a liquid crystal display (LCD), or an organic electro luminescence (EL) display device, or the like.

The first operation detector 84 detects an operation performed on a display surface of the display 82 and outputs a detection result to the display control device 30. The detection result is, for example, information indicating which position on a display surface of an image has been touched to what extent or operation information indicating an operation mode such as the time over which the operation was performed. For example, the first operation detector 84 detects the degree of change with respect to a reference value of a capacitance of a display surface, derives operation information indicating the mode of an operation on the basis of a detection result, and outputs the derived operation information to the display control device 30. The first operation detector 84 may derive operation information on the basis of a method such as a resistive film system or an infrared light scanning system.

The controller 86 controls the first touch panel 80 such that it is brought into an on state or an off state or displays a desired image on the display of the display 70 on the basis of an instruction of the display control device 30. The controller 86 transmits a detection result of the first operation detector 84 to the display control device 30.

The second touch panel 90 includes, for example, a display 92, a second operation detector 94, and a controller 96. The function of the display 92 and the function of the display 82 are the same, and the function of the second operation detector 94 and the function of the first operation detector 84 are the same. The function of the controller 96 and the function of the controller 86 are the same. However, a target to be controlled by the controller 96 is the display 92. The controller 96 transmits a detection result of the second operation detector 94 to the display control device 30.

The vehicle information display 100 is, for example, an LCD, an organic EL display device, or the like. The vehicle information display 100 is provided in the forward direction from the driver's seat on the plus Y-direction side of the first touch panel 80. The vehicle information display 100 displays information to be recognized by the driver during the driving of the vehicle such as the speed of the vehicle and the state of a driving source (for example, an operation state of an electric motor or an engine speed).

In the example of FIG. 2, the disposition of the first touch panel 80 and the second touch panel 90 in a right-hand drive vehicle is shown, but the vehicle information display 100, the first touch panel 80, and the second touch panel 90 are disposed in this order from a side in the minus Y-direction in a case of a left-hand drive vehicle.

### [Contents Displayed on First Display and Second Display]

FIG. 3 is a diagram showing an example of images displayed on the first touch panel 80 and the second touch panel 90. The first touch panel 80 includes a region 80AR. The region 80AR is a display region in which images such as predetermined information and an operation button are displayed on the basis of the control of the display control device 30. The operation button is a graphical user interface (GUI) switch.

The region 80AR includes, for example, a first display region 80AR-1 and a second display region 80AR-2. The first display region 80AR-1 is a region on the plus Y-direction side of the first touch panel 80. The second display region 80AR-2 is a region on the minus Y-direction side of the first touch panel 80. In the first touch panel 80, the first display region 80AR-1 is a region on a side closer to a driver's seat than the second display region 80AR-2 is (a side far from a seat next to the driver's seat). For example, the first display region 80AR-1 is a region smaller than the second display region 80AR-2. A ratio of the length of the first display region 80AR-1 in the Y-direction to the length of the second display region 80AR-2 in the Y-direction is a predetermined ratio such as 1:3 or 1:2.

In the example of FIG. 3, for example, a first operation button B1 is displayed in the first display region 80AR-1 so as to be superimposed on a predetermined content image. For example, the first operation button B1 is set to be biased to a side far from a seat next to the driver's seat in the vehicle width direction of the display 82 of the first touch panel 80. The “being biased” refers to being closer to a side farther from the seat next to the driver's seat than a side closer to the seat next to the driver's seat in the vehicle width direction of the display 82 of the first touch panel 80 and refers to, for example, being closer to a side farther from the seat next to the driver's seat than a side closer to the seat next to the driver's seat with the center of the first touch panel 80 in the vehicle width direction as a reference. For example, the first operation button B1 is set at an end of the display 82 in the plus Y-direction or in the vicinity of the end. For example, in a case where a region is divided into three regions or four regions in the Y-direction of the display 82 (or in a case where the region is divided into a predetermined number of regions), the first operation button B1 is set in the outermost (plus Y-direction) region obtained by the division. In addition, for example, a predetermined content image is displayed in the second display region 80AR-2. In the first display region 80AR-1, for example, a predetermined content image is not displayed, and only the first operation button B1 may be displayed.

The second touch panel 90 includes a region 90AR. The region 90AR is a display region in which images such as predetermined information and a second operation button B2 are displayed on the basis of the control of the display control device 30. The second operation button B2 is a GUI switch. The region 90AR includes, for example, a third display region 90AR-1 and a fourth display region 90AR-2. The third display region 90AR-1 is a region on the minus Y-direction side of the second touch panel 90. The fourth display region 90AR-2 is a region on the plus Y-direction side of the second touch panel 90. In the second touch panel 90, the third display region 90AR-1 is a region on a side closer to a seat next to the driver's seat (a side far from the driver's seat) than the fourth display region 90AR-2 is. For example, the third display region 90AR-1 is a region smaller than the fourth display region 90AR-2. The ratio of the length of the third display region 90AR-1 in the Y-direction to the length of the fourth display region 90AR-2 in the Y-direction is a predetermined ratio such as 1:3 or 1:2.

In the example of FIG. 3, for example, the second operation button B2 is displayed in the third display region 90AR-1 so as to be superimposed on a predetermined content image. The second operation button B2 is set to be biased to a side far from the driver's seat in the vehicle width direction of the display 92 of the second touch panel 90. The “being biased” refers to being closer to a side farther from the driver's seat than a side closer to the driver's seat in the vehicle width direction of the display 92 of the second touch panel 90 and refers to, for example, being closer to a side farther from the driver's seat than a side closer to the driver's seat with the center of the second touch panel 90 in the vehicle width direction as a reference. For example, the second operation button B2 is set at an end of the display 92 in the minus Y-direction or in the vicinity of the end. For example, in a case where a region is divided into three regions or four regions in the Y-direction of the display 92 (or in a case where the region is divided into a predetermined number of regions), the second operation button B2 is set in the outermost (minus Y-direction) region obtained by the division. For example, a predetermined content image is displayed in the fourth display region 90AR-2. In the third display region 90AR-1, for example, a predetermined content image is not displayed, and the second operation button B2 may be displayed in a case where an occupant is present on a seat next to the driver's seat.

For example, the third display region 90AR-1 for displaying the second operation button B2 and the fourth display region 90AR-2 for displaying a predetermined content (for example, a second content) may be set to be completely different display regions. For example, the third display region 90AR-1 may be a dedicated region in which the second operation button B2 is displayed, and the fourth display region 90AR-2 may be a dedicated region in which a predetermined content is displayed. A display region may be set such that a predetermined content displayed in the fourth display region 90AR-2 is displayed at least in a portion of a background of the third display region 90AR-1 for displaying the second operation button B2.

### [Contents Displayed in Display Region]

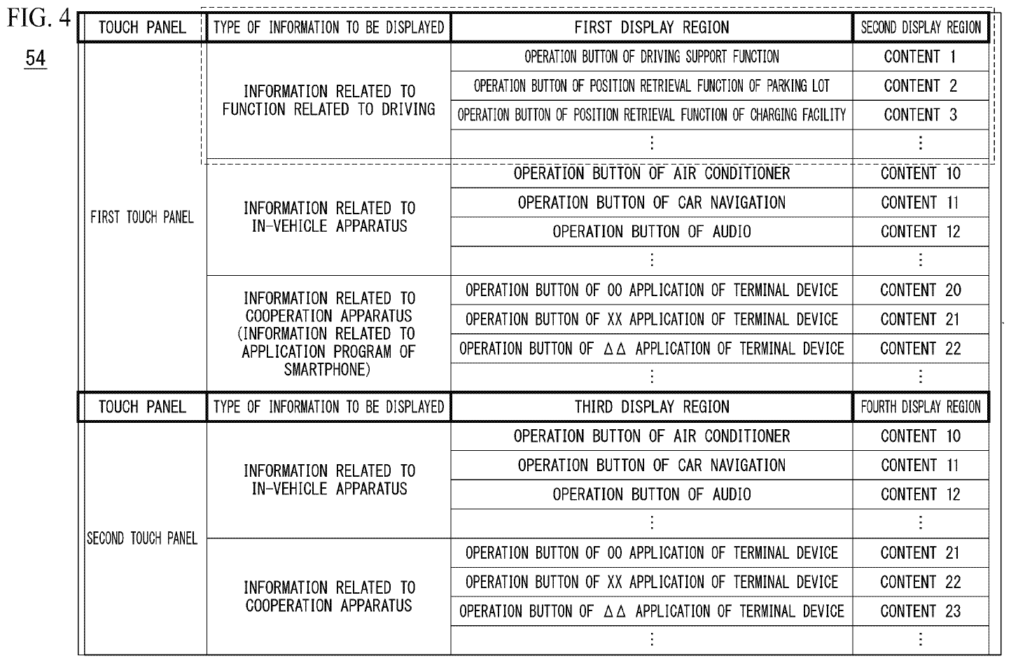

FIG. 4 is a diagram showing an example of details of the display correspondence information 54. The display correspondence information 54 is a list of information displayed on the first touch panel 80 and the second touch panel 90. For example, one or more first operation buttons B1 related to a “function related to driving”, an “in-vehicle apparatus”, and a “cooperation apparatus” are displayed in the first display region 80AR-1 of the first touch panel 80. The “first operation button B1 related to a function” is a button for executing a function and using a service to be provided using a function. The “first operation button B1 related to an apparatus” is a button for operating an apparatus and controlling an apparatus. An image determined in advance and a content corresponding to the operation of the first operation button B1 are displayed in the second display region 80AR-2.

The “function related to driving” includes, for example, a driving support function, a function of retrieving the position of a parking lot, and a function of retrieving the position of a charging facility. The driving support function includes, for example, an adaptive cruise control (ACC), a lane keep assist system (LKAS), a collision mitigation brake system (CMBS), and the like. When the first operation button B1 (an example of a “third operation button”) related to the driving support function (a function executed by a specific program) is operated, the driving support function is started or executed. In this case, for example, information such as a support function of the driving support function which is started or executed is displayed in the second display region 80AR-2.

The “in-vehicle apparatus” is an apparatus mounted inside the vehicle such as an air conditioner, a car navigation system, an audio apparatus, or a telephone. When the first operation button B1 related to the in-vehicle apparatus is operated, a power supply of a target in-vehicle apparatus is started, or a function of the in-vehicle apparatus is executed. In this case, for example, information such as the operation of the in-vehicle apparatus being started or executed, and a control state is displayed in the second display region 80AR-2.

The “cooperation apparatus” is an apparatus which is communicating with the cooperation control device 6. For example, information related to a cooperation apparatus is information related to a service which is provided by an application installed in a cooperation apparatus (portable terminal device) such as a smartphone. When the first operation button B1 related to the cooperation apparatus is operated, an application installed in the cooperation apparatus is started, or a function for executing an application is executed. In this case, for example, information of the application being started or executed and information of the service which is provided by the application are displayed in the second display region 80AR-2.

For example, one or more second operation buttons B2 related to an “in-vehicle apparatus” and a “cooperation apparatus” are displayed in the third display region 90AR-1 of the second touch panel 90. For example, the second operation button is an operation button which is displayed in only the first display region 80AR-1 and is not displayed in the third display region 90AR-1. A button for controlling a function related to driving is not displayed in the third display region 90AR-1. The operation button of the driving support function is displayed in only the first display region 80AR-1 so that it is operated by only a driver. An image determined in advance and a content corresponding to the operation of the second operation button B2 are displayed in the fourth display region 90AR-2.

For example, in the above-described example of FIG. 3, the first operation button B1 or the second operation button B2 related to a car navigation displayed in the first display region 80AR-1 or the third display region 90AR-1 is operated, and map information is displayed in the second display region 80AR-2 or the fourth display region 90AR-2.

An operation button which is not displayed may be present in the first display region 80AR-1, and an operation button displayed in only the first display region 80AR-1 or an operation button displayed in only the third display region 90AR-1 may be set by an occupant.

In each embodiment, description is given on the assumption that the display 70 includes a touch panel and an image is displayed on a display of the touch panel, but a region different from display regions (for example, the first display region 80AR-1 and the third display region 90AR-1) in which the first operation button B1 or the second operation button B2 is displayed may not be a touch panel. That is, display regions (for example, the second display region 80AR-2 and the fourth display region 90AR-2) in which the first operation button B1 and the second operation button B2 are not displayed may be simple displays that do not include a mechanism receiving the input of an operation of bringing an indicator into contact with a display.

### [Outline of Processing]

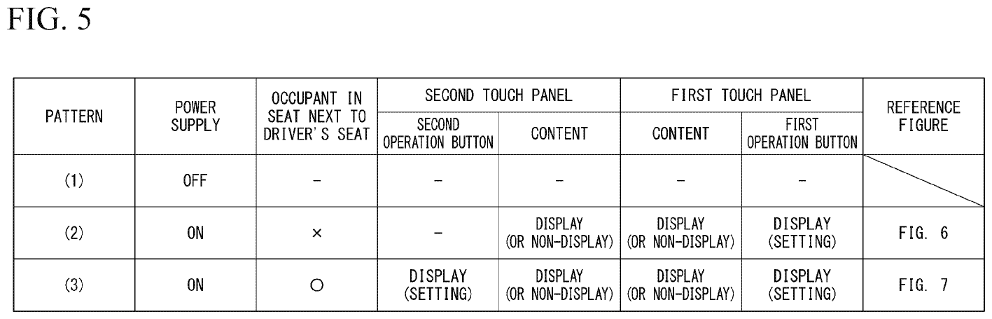

FIG. 5 is a diagram showing an outline of processing executed by the display control device 30. A pattern (1) is a state where the start button 10 is not operated. In this case, the display control device 30 controls the first touch panel 80 and the second touch panel 90 such that they are brought into an off state (an off state is maintained).

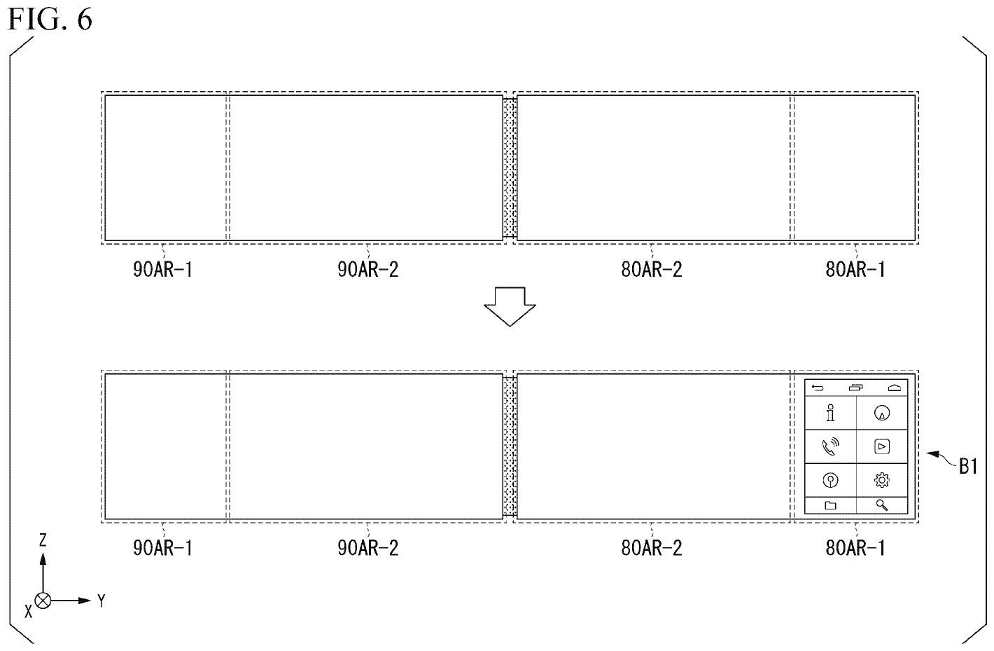

A pattern (2) in FIG. 5 is a state where the start button 10 is operated and an occupant is not sitting on a seat next to a driver's seat. The display control device 30 controls the first touch panel 80 such that it is brought into an on state, displays the first operation button B1 in the first display region 80AR-1 of the first touch panel 80, and displays a predetermined content in the second display region 80AR-2. The “on state” means that a power supply is in an on state. The display control device 30 controls the second touch panel 90 such that it is brought into an on state, and displays a predetermined content in the fourth display region 90AR-2 of the second touch panel 90. FIG. 6 is a diagram showing an example of a change in a display mode in the pattern (2). The display of predetermined contents in the second display region 80AR-2 and the fourth display region 90AR-2 may be omitted as shown in FIG. 6.

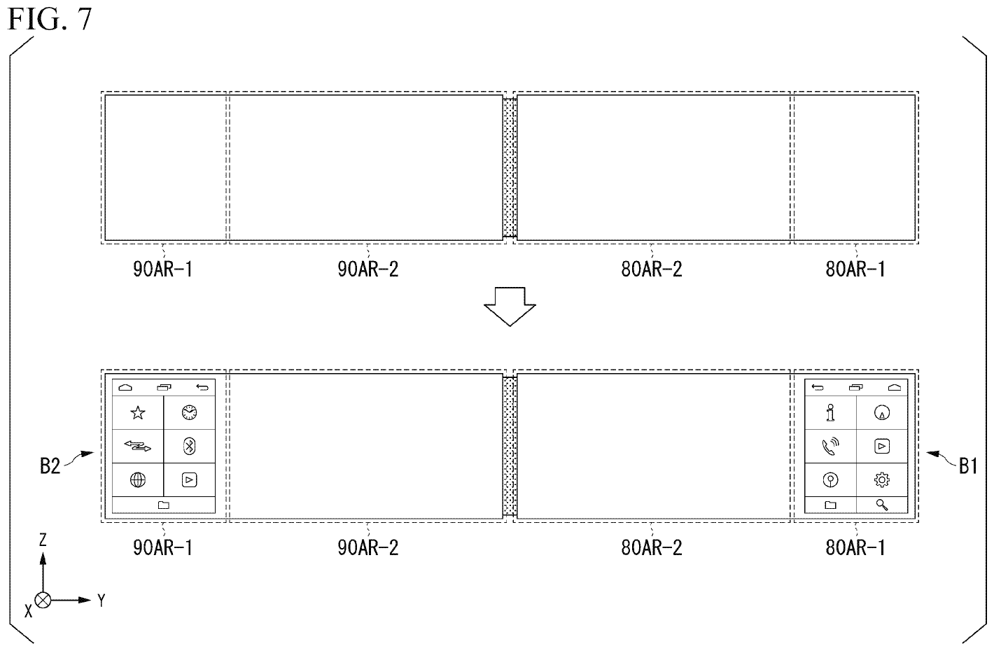

A pattern (3) in FIG. 5 is a state where the start button 10 is operated and an occupant is sitting on a seat next to a driver's seat. A display mode of the first touch panel 80 is the same as that of the pattern (2). The display control device 30 controls the second touch panel 90 such that it is brought into an on state, displays the second operation button B2 in the third display region 90AR-1 of the second touch panel 90, and displays a predetermined content in the fourth display region 90AR-2. FIG. 7 is a diagram showing an example of a change in a display mode in the pattern (3). The display of predetermined contents in the second display region 80AR-2 and the fourth display region 90AR-2 may be omitted as shown in FIG. 7.

### [Flowchart]

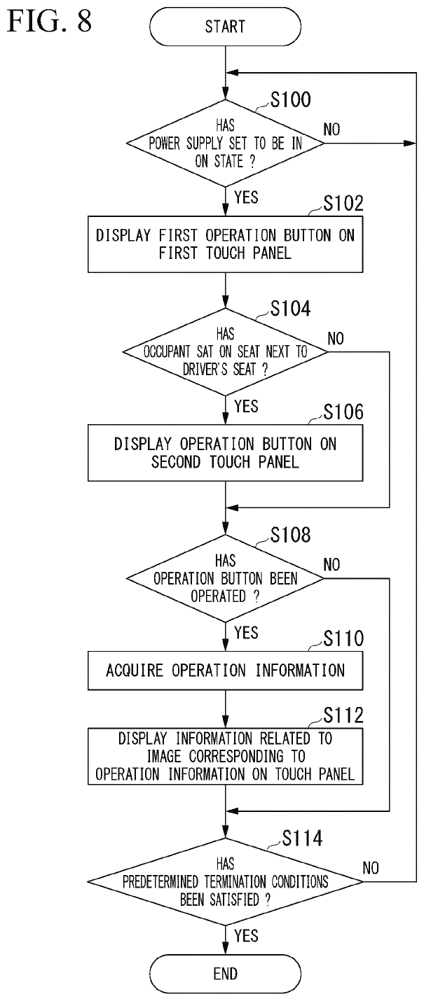

FIG. 8 is a flowchart showing a flow of processing executed by the display control device 30. In the present processing, it is assumed that the control of a display mode in the second display region 80AR-2 and the fourth display region 90AR-2 is not considered.

First, the display controller 36 determines whether or not the start button 10 has been operated and a power supply of the vehicle has been set to be in an on state (step

S100). In a case where it is determined that the power supply has been set in an on state, the display controller 36 displays the first operation button B1 on the first touch panel 80 (step S102). Next, the occupant determiner 34 determines whether or not an occupant is sitting on the seat next to the driver's seat (step S104). In a case where an occupant is not sitting on the seat next to the driver's seat, the processing proceeds to the process of step S108.

In a case where an occupant is sitting on the seat next to the driver's seat, the display controller 36 displays the second operation button B2 on the second touch panel 90 (step S106). Next, the display controller 36 determines whether or not the first operation button B1 or the second operation button B2 has been operated (step S108).

In a case where the first operation button B1 and the second operation button B2 are displayed, it is determined whether or not any one operation button has been operated. In a case where the first operation button B1 is displayed, it is determined whether or not the first operation button B1 has been operated. In a case where no operation button has been operated, the processing proceeds to the process of step S114.

In a case where an operation button has been operated, the display controller 36 acquires operation information (step S110) and displays information related to an image corresponding to the acquired operation information in a relevant display (the first touch panel 80 or the second touch panel 90) (step S112). In this case, the instruction analyzer 38 converts the operation information into analyzed information and outputs the changed analyzed information to a target apparatus.

Next, the display controller 36 determines whether or not predetermined termination conditions have been satisfied (step S114). In a case where the predetermined termination conditions have not been satisfied, the processing returns to the process of step S100. The predetermined termination conditions include, for example, a condition that the power supply of the vehicle is set to be in an off state, a condition that the power supply of the display 70 is set to be in an off state, a condition that an operation for not displaying an operation button on the display 70 has been performed by an occupant, and the like. In a case where the predetermined termination conditions are satisfied, the processing of one routine of this flowchart is terminated.

As described above, the display controller 36 displays the first operation button B1 in the first display region 80AR-1 of the first touch panel 80 regardless of the presence of a driver in the driver's seat and displays the second operation button B2 in the third display region 90AR-1 of the second touch panel 90 in a case where an occupant is present in the seat next to the driver's seat, and thus it is possible to improve visibility and operability for an occupant.

For example, even when the second operation button B2 is displayed on the second touch panel 90, it may be difficult for the driver to operate the second operation button and information of the second operation button B2 may be unnecessary information. For this reason, in a case where an occupant is not present in the seat next to the driver's seat, the second operation button B2 is not displayed, thereby reducing troublesomeness for the driver and improving visibility related to the display of a content. In a case where an occupant is present in the seat next to the driver's seat, the second operation button B2 is displayed on the second touch panel 90, and thus the occupant in the seat next to the driver's seat can operate the second operation button B2 spontaneously or in response to the driver's request. For this reason, operability for an occupant in the seat next to the driver's seat or convenience for the driver is improved.

For example, in a case where an occupant is not present in the seat next to the driver's seat, the state of the first operation detector 84 may be controlled such that an operation to be performed in the third display region 90AR-1 is not detected. In a case where an occupant is not present in the seat next to the driver's seat, the first operation detector 84 detects an operation, but each unit may be controlled such that the subsequent processes are not performed (for example, control may be performed such that the controller 86 does not output a detection result to the display control device 30).

According to the above-described first embodiment, the display control device 30 sets one or more second operation buttons B2 for receiving an input operation in the second touch panel 90 in a case where an occupant is present in the seat next to the driver's seat, and the display control device 30 does not set the second operation button in the second touch panel 90 in a case where an occupant is not present in the seat next to the driver's seat, and thus it is possible to achieve both visibility and operability.

### SECOND EMBODIMENT

Hereinafter, a second embodiment will be described. In the second embodiment, details of the processing of the display control device 30 and the second display 80 in a case where an occupant is not present in a seat next to a driver's seat will be described. Hereinafter, differences from the first embodiment will be mainly described.

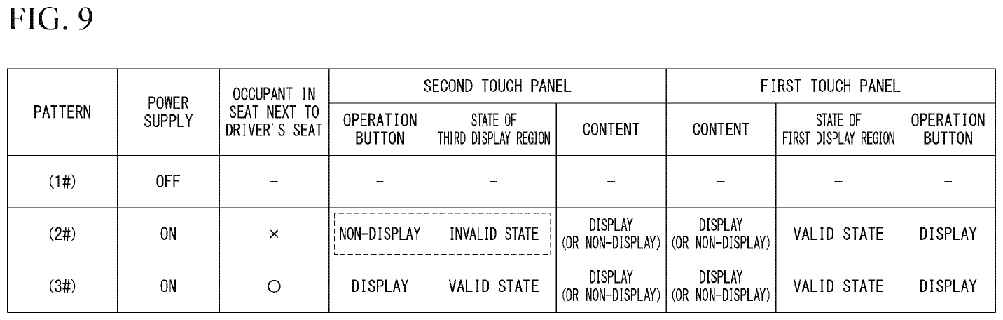

FIG. 9 is a diagram showing an outline of the processing of a display controller 36 according to the second embodiment. Differences from the details of FIG. 5 will be mainly described. A pattern (1#) is a state where a start button 10 is not operated. In this case, the display controller 36 controls a first touch panel 80 and a second touch panel 90 such that they are brought into an off state.

A pattern (2#) is a state where the start button 10 is operated and an occupant is not sitting in a seat next to a driver's seat. The second touch panel 90 controls a display 92 such that it is brought into an on state and controls a detection state of a third display region 90AR-1 such that it is brought into an invalid state. The invalid state is a state where an operation itself is not detected even when the operation is performed in the third display region 90AR-1, or a state where an operation is detected, but a process of transmitting information indicating a detection result to the display controller 36 is stopped. The first touch panel 80 controls a first display 82 such that it is brought into an on state and controls a detection state of a first display region 80AR-1 such that it is brought into a valid state. The valid state is a state where an operation is detected in a case where an operation is performed in the first display region 80AR-1. In the case of the valid state, the content of the operation is reflected in the control of a target apparatus and the execution of a function.

A pattern (3#) is a state where the start button 10 is operated and an occupant is sitting on the seat next to the driver's seat. The display controller 36 displays a first operation button B1 in the first display region 80AR-1 in a valid state and displays a second operation button B2 in the third display region 90AR-1 in a valid state.

### [Processing in Invalid State]

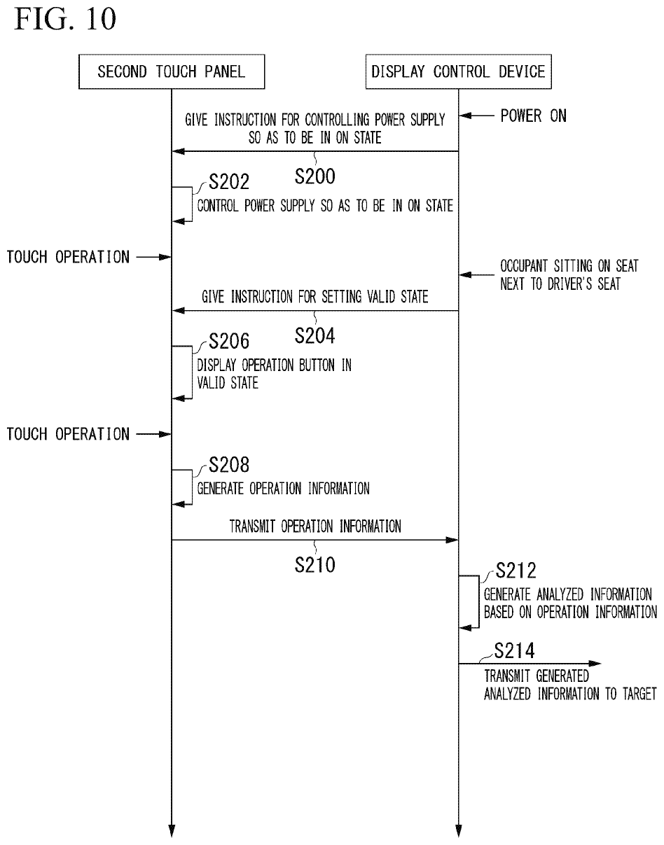

FIG. 10 is a sequence diagram showing a flow of processing in an invalid state. First, when the start button 10 is operated, the display controller 36 gives an instruction for controlling a power supply of the second touch panel 90 such that it is brought into an on state to the second touch panel 90 (step S200). Next, a controller 96 of the second touch panel 90 controls a power supply of the host device such that it is brought into an on state (step S202). In a case where a touch operation is performed on the third display region 90AR-1 after step S202, the controller 96 does not generate operation information due to being in an invalid state. When an occupant sits on the seat next to the driver's seat, the display controller 36 gives an instruction for setting a control state to be a valid state to the second touch panel 90 (step S204).

The controller 96 of the second touch panel 90 displays the second operation button B2 in a valid state on the basis of the instruction given in step S204 (step S206). When a touch operation is performed on the second operation button B2 in a valid state, the controller 96 generates operation information on the basis of a touch position and the like (step S208), and transmits the generated operation information to the display controller 36 (step S210).

Next, the display controller 36 converts the operation information into analyzed information (step S212), and transmits the analyzed information obtained by the conversion to a target to be controlled (step S214). Thereby, for example, an in-vehicle apparatus to be controlled is operated in response to an operation, or a function of a target application is executed.

In this manner, in a case where an occupant is not present in the seat next to the driver's seat, the second touch panel 90 controls a function of detecting a position where a touch operation is performed such that it is brought into an off state. In a case where an occupant is not present in the seat next to the driver's seat, the second touch panel 90 detects a position where a touch operation is performed, but may stop processes to be performed after the detection (a process of generating operation information, and a process of transmitting operation information).

### [Another Example of Invalid State]

An invalid state may be a state where the display controller 36 acquires information indicating a detection result for an operation from the second touch panel 90, but does not process the acquired information.

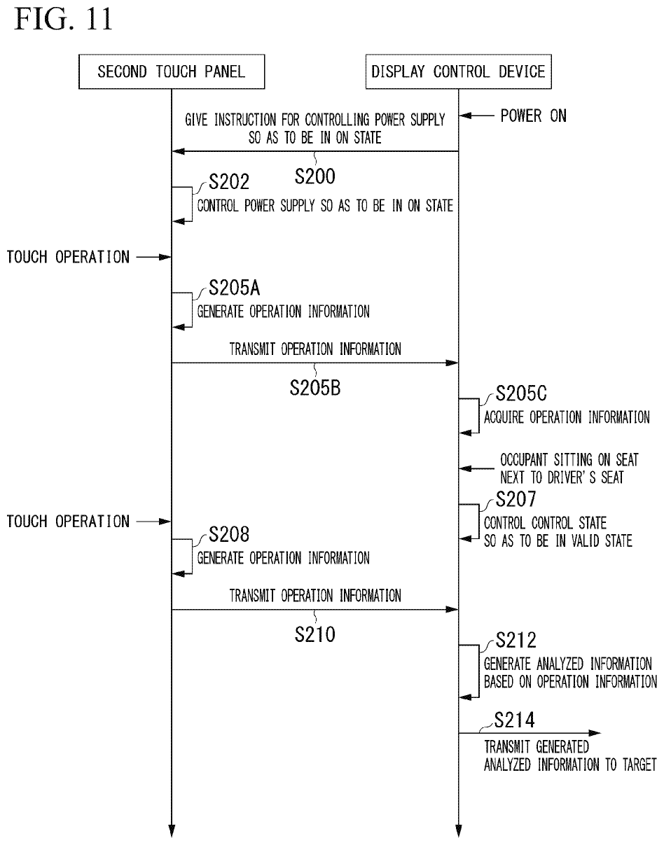

FIG. 11 is a sequence diagram showing a flow of another processing in an invalid state. Differences from the sequence in FIG. 10 will be mainly described. The processes of steps S200 and S202 and steps S208 to S214 in FIG. 11 are the same as the respective processes in FIG. 10.

In a case where a touch operation is performed on the third display region 90AR-1 after the process of step S202, the controller 96 generates operation information on the basis of a touch position and the like (step S205A), and transmits the generated operation information to the display controller 36 (step S205B). The display controller 36 acquires the operation information transmitted in step S205B (step S205C). In this case, since the display controller 36 is in an invalid state, the next process is not performed even when the operation information is acquired.

When an occupant sits on the seat next to the driver's seat, the display controller 36 controls a control state such that it is brought into a valid state (step S207). When a touch operation is performed on the second touch panel 90, the controller 96 generates operation information on the basis of a touch position and the like (step S208), and transmits the generated operation information to the display controller 36 (step S210). When the display controller 36 acquires operation information in a valid state, the display controller may generate analyzed information on the basis of the acquired information (step S212) and transmits the generated analyzed information to a target to be controlled (step S214).

According to the above-described second embodiment, a display system 1 sets an operation to be in an invalid state even when an operation is performed in the third display region 90AR-1 in a case where an occupant is not present in the seat next to the driver's seat, and thus it is possible to curb power consumption and unnecessary processing.

### THIRD EMBODIMENT

Hereinafter, a third embodiment will be described. In the first embodiment, description has been given on the assumption that the display control device 30 determines whether or not an occupant is sitting on a seat next to a driver's seat on the basis of a detection result of the seating sensor 12. On the other hand, in the third embodiment, a display control device 30 determines whether or not an occupant is sitting on a seat next to a driver's seat on the basis of an image captured by an in-cabin camera, a detection result of a door sensor, and a detection result of a seat belt sensor. Hereinafter, differences from the first embodiment will be described.

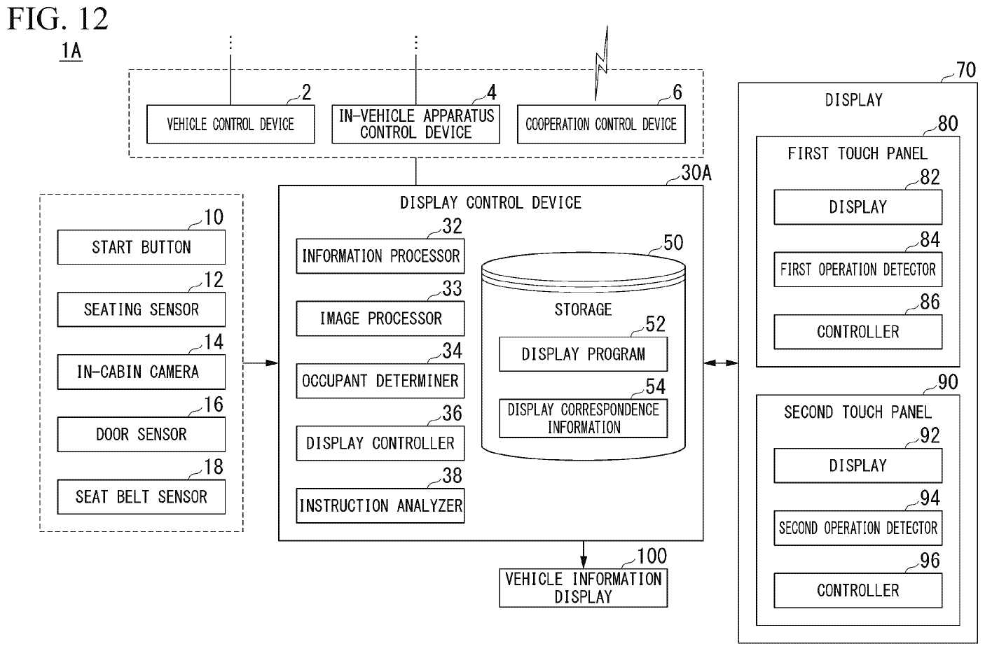

FIG. 12 is a diagram showing an example of a functional configuration of a display system 1A according to the third embodiment. The display system 1A further includes an in-cabin camera 14, a door sensor 16, and a seat belt sensor 18 in addition to the functional configuration of the display system 1 according to the first embodiment.

The in-cabin camera 14 is a digital camera using a solid imaging element such as a charge coupled device (CCD) or a complementary metal oxide semiconductor (CMOS). The in-cabin camera 14 images an occupant sitting on the seat next to the driver's seat. The door sensor 16 detects whether the door of the seat next to the driver's seat is in an open state or a closed state. The seat belt sensor 18 detects whether or not the occupant in the seat next to the driver's seat has fastened a seat belt.

The display system 1A further includes a display control device 30A instead of the display control device 30. The display control device 30A further includes an image processor 33 in addition to the functional configuration of the display control device 30 according to the first embodiment. The image processor 33 analyzes an image captured by the in-cabin camera 14, determines whether or not an occupant is sitting on the seat next to the driver's seat, and outputs a determination result to an occupant determiner 34. The image processor 33 derives, for example, a feature amount from the image captured by the in-cabin camera 14. The image processor 33 determines that an occupant is sitting on the seat next to the driver's seat in a case where a distribution of a feature amount indicating an occupant stored in a storage 50 in advance matches a distribution of the derived feature amount.

For example, the occupant determiner 34 determines whether or not an occupant is sitting on the seat next to the driver's seat on the basis of one or more detection results among a determination result of the image processor 33, a detection result of the door sensor 16, and a detection result of the seat belt sensor 18. For example, the occupant determiner 34 may determine that an occupant is sitting on the seat next to the driver's seat in a case where (a) the door sensor 16 detects that the door is set to be in an open state and then (b) the door is set to be in a closed state, (c) the image processor 33 determines that an occupant is sitting on the seat next to the driver's seat, and (d) the seat belt sensor 18 detects that the driver has fastened the seat belt. The occupant determiner 34 may determine that an occupant is sitting on the seat next to the driver's seat in a case where the above-described conditions of (a) and (d) are satisfied.

According to the above-described third embodiment, since the display control device 30 can also determine whether or not an occupant is present in a seat next to a driver's seat using information other than the seating sensor 12, it is possible to determine the presence or absence of an occupant in the seat next to the driver's seat with higher accuracy.

### FOURTH EMBODIMENT

Hereinafter, a fourth embodiment will be described. In the fourth embodiment, in a case where an operation button is changed from a non-display state to a display state or from a display state to a non-display state, the operation button is displayed in a display region in a sliding manner Hereinafter, differences from the first embodiment will be described.

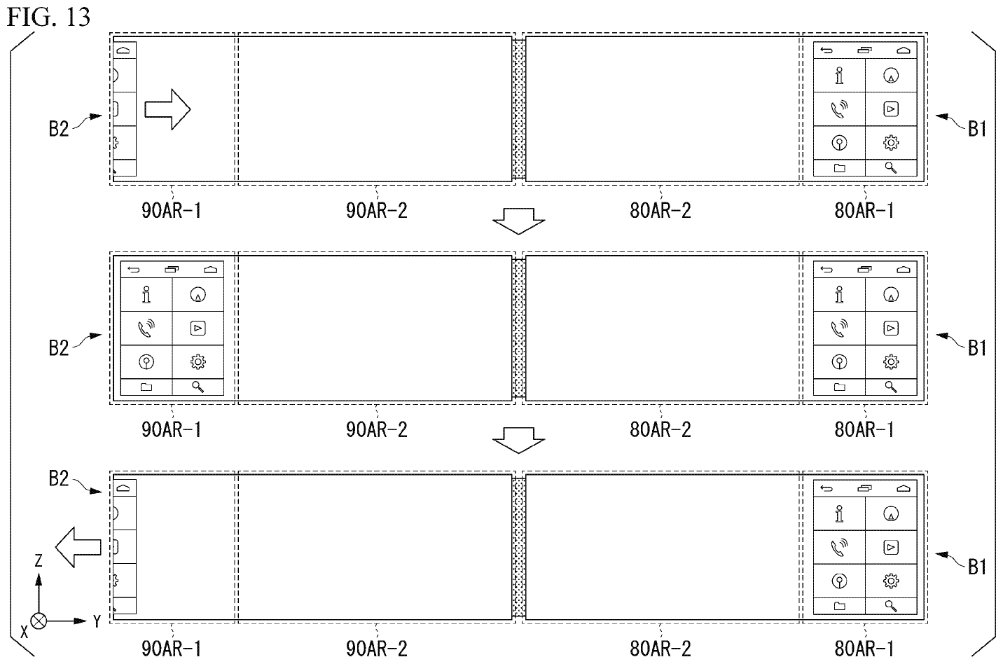

FIG. 13 is a diagram showing an example of a state when an operation button is controlled to be in a display state or a non-display state. In a case where a second operation button B2 is displayed in a third display region 90AR-1, a display controller 36 controls a display mode so that the second operation button B2 is displayed while sliding from the minus Y-direction to the plus Y-direction as shown in an upper drawing of FIG. 13. In this case, when a function (application) related to the second operation button B2 displayed in the third display region 90AR-1 is not started, the application which is not started may be controlled such that it is brought into a start state in accordance with the display of the second operation button B2 or may be controlled such that it is brought into a start state in accordance with an operation performed on the second operation button B2.

Further, in a case where the display controller 36 displays the second operation button B2 in the third display region 90AR-1 and then sets the second operation button B2 to be in a non-display state in the third display region 90AR-1 as shown in a middle drawing of FIG. 13, the display controller controls a display mode so that the second operation button B2 is set to be in a non-display mode while sliding from the plus Y-direction to the minus Y-direction as shown in a lower drawing of FIG. 13. In this case, a start state of a function (application) related to the second operation button B2 displayed in the third display region 90AR-1 may be maintained. When a function (application) related to the operation of the second operation button B2 which is not displayed in the third display region 90AR-1 is in a start state, the function may be controlled such that it is terminated. However, a function of an application related to a first operation button B1 may be excluded from a target to be terminated.

According to the above-described fourth embodiment, the display controller 36 controls an operation button such that it is displayed in a sliding manner or controls an operation button such that it is brought into a non-display state, and thus it is possible to produce an effect of improving sensitivity of an occupant.

### FIFTH EMBODIMENT

Hereinafter, a fifth embodiment will be described. In the fifth embodiment, the positions of a third display region 90AR-1 and a fourth display region 90AR-2 in a second touch panel 90 are different from the positions in the first embodiment.

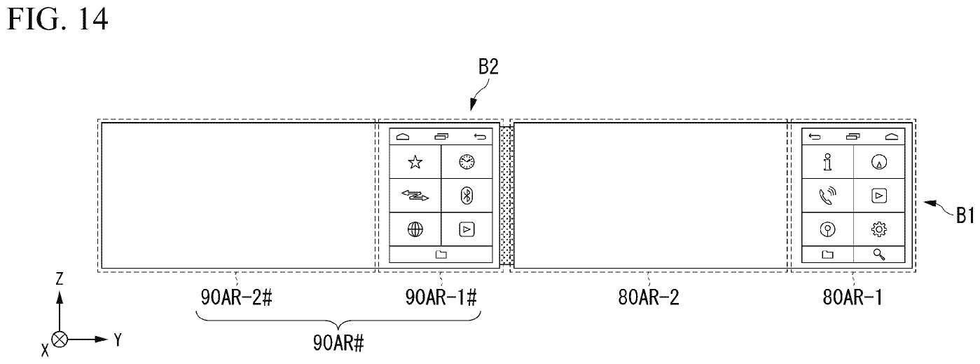

FIG. 14 is a diagram showing an example of operation buttons displayed on a first touch panel 80 and a second touch panel 90 according to the fifth embodiment. For example, the second touch panel 90 includes a region 90AR#. The region 90AR# includes, for example, a third display region 90AR-1# and a fourth display region 90AR-2#. The third display region 90AR-1# is a region on the plus Y-direction side of the second touch panel 90. The fourth display region 90AR-2# is a region on the minus Y-direction side of the second touch panel 90. The third display region 90AR-1# is a region on a side closer to a driver's seat than the fourth display region 90AR-2# in the second touch panel 90. For example, the third display region 90AR-1# is a region smaller than the fourth display region 90AR-2#. A ratio of the length of the third display region 90AR-1# in the Y-direction to the length of the fourth display region 90AR-2# in the Y-direction is a predetermined ratio such as 1:3 or 1:2.

The positions of a first display region 80AR-1 and a fourth display region 90AR-2 in the first touch panel 80 may be different from the positions in the first embodiment.

According to the above-described fifth embodiment, it is possible to exhibit the same effects as in the first embodiment.

### SIXTH EMBODIMENT

Hereinafter, a sixth embodiment will be described. In the sixth embodiment, a first display region (an example of a “first specific region”) 80AR-1, a second display region 80AR-2, a third display region (an example of a “second specific region”) 90AR-1, and a fourth display region 90AR-2 are provided in one display.

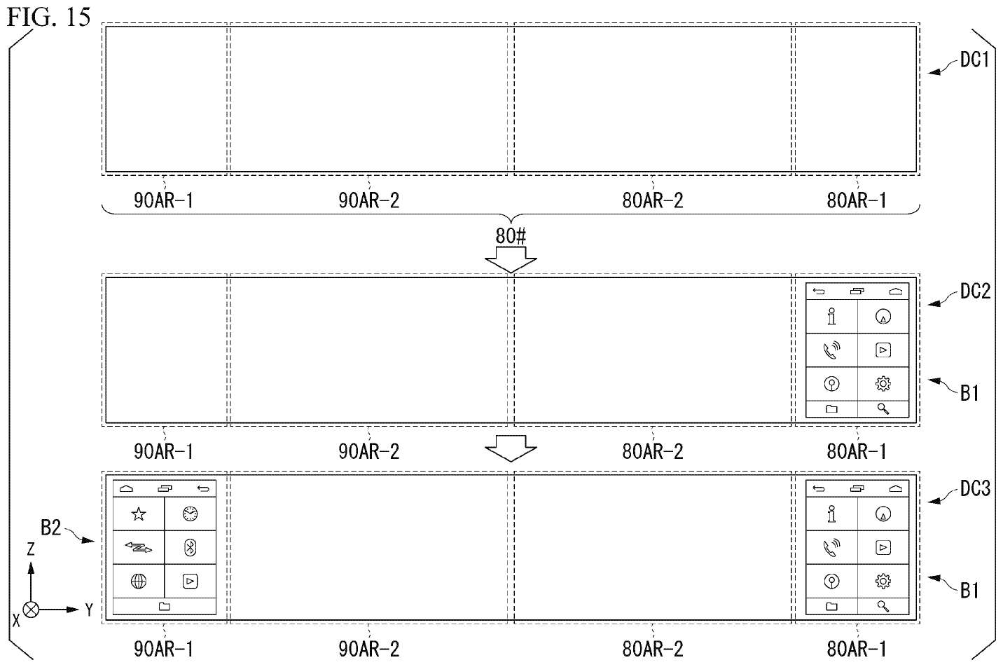

FIG. 15 is a diagram showing an example of a touch panel 80# according to a sixth embodiment. A state DC1 in FIG. 15 shows an example of the state of the touch panel 80# when a power supply of a vehicle is in an off state. A first display region 80AR-1 is a region on the plus Y-direction side of the touch panel 80#. A third display region 90AR-1 is a region on the minus Y-direction side of the touch panel 80#. A second display region 80AR-2 and a fourth display region 90AR-2 are regions interposed between the first display region 80AR-1 and the third display region 90AR-1 in the Y-direction.

A state DC2 in FIG. 15 shows an example of an image displayed on the touch panel 80# when the power supply of the vehicle is in an on state. When the power supply of the vehicle is set to be in an on state, a first operation button B1 is displayed in the first display region 80AR-1 of the touch panel 80#.

A state DC3 in FIG. 15 shows an example of an image displayed on the touch panel 80# when an occupant sits on a seat next to the driver's seat in the state DC2. In this case, the first operation button B1 is displayed in the first display region 80AR-1 of the touch panel 80#, and a second operation button B2 is displayed in the third display region 90AR-1.

According to the above-described sixth embodiment, it is possible to exhibit the same effects as in the first embodiment.

### SEVENTH EMBODIMENT

Hereinafter, a seventh embodiment will be described. In the seventh embodiment, a display 70 includes three or more displays.

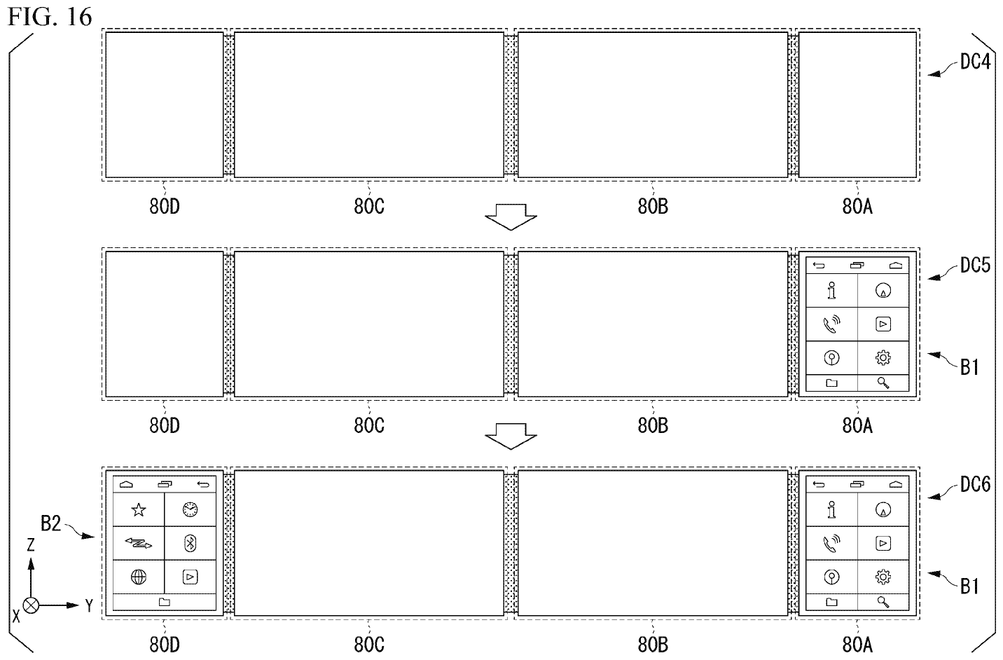

FIG. 16 is a diagram showing an example of a display included in the display 70 according to the seventh embodiment. The display 70 includes an A-th touch panel 80A, a B-th touch panel 80B, a C-th touch panel 80C, and a D-th touch panel 80D. A combination of the A-th touch panel 80A and the B-th touch panel 80B is an example of a “first display group”, and a combination of a C-th touch panel 80C and a D-th touch panel 80D is an example of a “second display group”.

The A-th touch panel 80A is provided in the forward direction (X-direction) from a driver's seat in an instrument panel inside a vehicle. The B-th touch panel 80B is provided at a position (a position on the minus Y-direction side) in the vehicle width direction (Y-direction) with respect to the A-th touch panel 80A and closer to a seat next to the driver's seat than the A-th touch panel 80A. The C-th touch panel 80C is provided at a position in the vehicle width direction with respect to the B-th touch panel 80B and closer to the seat next to the driver's seat than the B-th touch panel 80B. The D-th touch panel 80D is provided at a position in the vehicle width direction with respect to the C-th touch panel 80C and closer to the seat next to the driver's seat than the C-th touch panel 80C. For example, the sizes of the A-th touch panel 80A and the D-th touch panel 80D are first sizes, and the sizes of the B-th touch panel 80B and the C-th touch panel 80C are second sizes. A ratio of the second size to the first size is a predetermined ratio such as 1:3 or 1:2.

Although not shown in the drawing, each of the A-th touch panel 80A to the D-th touch panel 80D includes a display, an operation detector, a controller, and the like which are included in a first touch panel 80 or a second touch panel 90.

A state DC4 in FIG. 16 shows an example of the state of the touch panel 80 when a power supply of a vehicle is in an off state. A state DC5 in FIG. 16 shows an example of images displayed on the A-th touch panel 80A to the D-th touch panel 80D when the power supply of the vehicle is in an on state. When the power supply of the vehicle is set to be in an on state, a first operation button B1 is displayed on the A-th touch panel 80A. A state DC6 in FIG. 16 shows an example of an image displayed on the D-th touch panel 80D in a case where an occupant sits on the seat next to the driver's seat in the state DC5. In this case, a second operation button B2 is displayed on the D-th touch panel 80D.

According to the above-described seventh embodiment, it is possible to exhibit the same effects as in the first embodiment.

Contents in the above-described first to seventh embodiments may be appropriately implemented in combination. In the above-described embodiments, although description has been given on the assumption that the display controller 36 sets (displays) the first operation button B1 in a case where the start button 10 is operated, and determines whether or not to set (display) the second operation button B2 on the second touch panel 90 on the basis of the presence or absence of an occupant in the seat next to the driver's seat, and alternatively, the processing may be performed in a case where predetermined conditions are satisfied. The predetermined conditions includes, for example, a condition that a door of the vehicle has been controlled such that it is brought into an open state, a condition that a smart key (a portable apparatus, a key fob) has been operated and the vehicle has received predetermined information output using the smart key, a condition that the vehicle has been stopped, a condition that predetermined setting has been performed by a user, and the like.

### [Hardware Configuration]

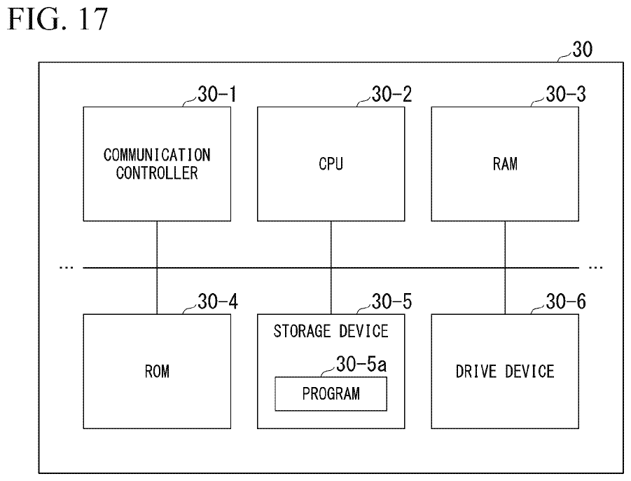

FIG. 17 is a diagram showing an example of a hardware configuration of the display control device 30 according to the embodiment. As shown in the drawing, the display control device 30 is configured such that a communication controller 30-1, a CPU 30-2, a random access memory (RAM) 30-3 used as a working memory, a read only memory (ROM) 30-4 storing a boot program and the like, a storage device 30-5 such as a flash memory or a hard disk drive (HDD), a drive device 30-6, and the like are connected to each other through an internal bus or a dedicated communication line. The communication controller 30-1 communicates with components other than the display control device 30. A program 30-5a to be executed by the CPU 30-2 is stored in the storage device 30-5. This program is expanded in the RAM 30-3 using a direct memory access (DMA) controller (not shown) or the like and is executed by the CPU 30-2.

Thereby, some or all of the information processor 32, the occupant determiner 34, the display controller 36, and the instruction analyzer 38 are realized.

The above-described embodiments can be expressed as follows.

A vehicle display device including:

a first display which is provided at a position where the first display is visually recognizable by a driver inside a vehicle and has a touch panel function in at least a portion of the first display;

a second display which is provided at a position closer to a seat next to the driver's seat than the first display is in a vehicle width direction and has a touch panel function in at least a portion of the second display;

a storage device which stores a program; and

a hardware processor,

wherein the hardware processor is configured to execute the program stored in the storage device to set one or more first operation buttons for receiving an input operation in the first display irrespective of the presence or absence of an occupant in the driver's seat, to set one or more second operation buttons for receiving an input operation in the second display in a case where an occupant is present in the seat next to the driver's seat, and not to set the second operation button in the second display in a case where an occupant is not present in the seat next to the driver's seat.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle display device comprising:
a first display which is provided at a position where the first display is visually recognizable by a driver inside a vehicle and has a touch panel function in at least a portion of the first display;
a second display which is provided at a position which is closer to a seat next to the driver's seat than the first display is in a vehicle width direction and has a touch panel function in at least a portion of the second display; and
a controller which is configured to set one or more first operation buttons for receiving an input operation in the first display irrespective of the presence or absence of an occupant in the driver's seat, set one or more second operation buttons for receiving an input operation in the second display in a case where an occupant is present in the seat next to the driver's seat, and not set the second operation button in the second display in a case where an occupant is not present in the seat next to the driver's seat.

2. The vehicle display device according to claim 1, wherein the controller sets the second operation button to a position that is biased to a side far from the driver's seat in the vehicle width direction of the second display in a case where the second operation button is set in the second display.

3. The vehicle display device according to claim 1, wherein the controller is configured to set the first operation button to a position that is biased to a side far from the seat next to the driver's seat in the vehicle width direction of the first display.

4. The vehicle display device according to claim 1, wherein the controller further displays one or more first contents in the first display irrespective of the presence or absence of an occupant in the driver's seat.

5. The vehicle display device according to claim 1, wherein the controller further displays one or more second contents in the second display in a case where an occupant is present in the seat next to the driver's seat.

6. The vehicle display device according to claim 1, wherein the controller displays a second content without setting the second operation button in the second display in a case where an occupant is not present in the seat next to the driver's seat.

7. The vehicle display device according to claim 1, wherein the controller is configured to set one or more third operation buttons for receiving an operation of a function to be executed using a specific program in the first display irrespective of the presence or absence of an occupant in the driver's seat, and does not set the third operation button in the second display even when an occupant is present in the seat next to the driver's seat.

8. A vehicle display device comprising:
a first display group which is provided at a position where the first display group is visually recognizable by a driver inside a vehicle and includes one or more first displays having a touch panel function in at least a portion of the first display;
a second display group which is provided at a position which is closer to a seat next to the driver's seat than that of the first display group is in a vehicle width direction, includes a plurality of second displays, and includes one or more second displays having a touch panel function in at least a portion of the second display; and
a controller which is configured to set one or more first operation buttons for receiving an input operation in the one or more first displays of the first display group irrespective of the presence or absence of an occupant in the driver's seat, set one or more second operation buttons for receiving an input operation in the one or more second displays of the second display group in a case where an occupant is present in the seat next to the driver's seat, and does not set the second operation button in the one or more second displays of the second display group in a case where an occupant is not present in the seat next to the driver's seat.

9. A vehicle display device comprising:
a display which is provided at a position where the display is visually recognizable by a driver inside a vehicle and an occupant in a seat next to the driver's seat and has a touch panel function in at least a portion of the display; and
a controller which is configured to set a first operation button for receiving one or more input operations in a first specific region of the display irrespective of the presence or absence of an occupant in the driver's seat, set one or more second operation buttons for receiving an input operation in a second specific region in a case where an occupant is present in the seat next to the driver's seat, in a vehicle width direction the second specific region being closer to the seat next to the driver's seat than the first specific region is, and not set the one or more second operation buttons in the second specific region in a case where an occupant is not present in the seat next to the driver's seat.

10. A vehicle display method comprising:
causing a computer provided in a vehicle
setting one or more first operation buttons for receiving an input operation in a first display which is provided at a position where the first display is visually recognizable by a driver inside the vehicle irrespective of the presence or absence of an occupant in the driver's seat and has a touch panel function in at least a portion of the first display,
setting one or more second operation buttons for receiving an input operation in a second display which is provided at a position which is closer to a seat next to the driver's seat than that of the first display is in a vehicle width direction in a case where an occupant is present in the seat next to the driver's seat and has a touch panel function in at least a portion of the second display, and
not setting the second operation button in the second display in a case where an occupant is not present in the seat next to the driver's seat.
